(19) United States
(12) Patent Application Publication
(10) Pub. No.: US 2014/0272129 A1
(43) Pub. Date: Sep. 18, 2014

(54) COMPLIANT PERMEABLE GLUE APPLICATOR

(71) Applicant: APPLE INC., Cupertino, CA (US)

(72) Inventors: Santhana Krishnan BALAJI, Cupertino, CA (US); Benjamin M. RAPPOPORT, San Francisco, CA (US)

(73) Assignee: Apple Inc., Cupertino, CA (US)

(21) Appl. No.: 13/865,096

(22) Filed: Apr. 17, 2013

Related U.S. Application Data
(60) Provisional application No. 61/792,958, filed on Mar. 15, 2013.

(51) Int. Cl. C09J 5/00

(52) U.S. Cl. CPC C09J 5/00
USPC 427/207.1; 118/256

(57) ABSTRACT

An adhesive applicator including an adhesive dispenser to provide adhesive at a pressure and a compliant head adapted to rotate about a symmetry axis is provided. The compliant head includes a permeable material to provide the adhesive to an adhesive layer on a top surface of a substrate. The adhesive applicator may include a driver coupled to move the compliant head so that the symmetry axis forms a trajectory on a substrate. An applicator head including a foam matrix having pores with a pre-selected pore diameter and having a compliant surface to accommodate substrate geometry is also provided. The foam matrix is elastically deformable upon contact with the substrate geometry. A method for applying an adhesive layer to a substrate using an adhesive applicator as above is also provided.

### CROSS REFERENCE TO RELATED APPLICATIONS

The present application claims the benefit under 35 U.S.C. 119(e) of U.S. Prov. Pat. Appl. No. 61/792,958, entitled “COMPLIANT PERMEABLE GLUE APPLICATOR,” by Santhana Krishnan BALAJI, et al. filed on Mar. 15, 2013, the contents of which are hereby incorporated herein by reference, in their entirety, for all purposes.

The present disclosure is related to U.S. patent application entitled “HEATED ROLLER HEAD BONDING PROCESS,” by Santhana K. Balaji, Sui-Long Wong, and Andrew D. Lauder, currently filed herewith under Attorney Docket No. P17640US1/16830US.1, the contents of which are hereby incorporated by reference in their entirety, for all purposes.

### FIELD OF THE DESCRIBED EMBODIMENTS

The described embodiments relate generally to methods, devices, and systems for applying an adhesive layer on a substrate having a complex profile. More particularly, embodiments in the present disclosure relate to a compliant permeable adhesive applicator and methods for its use in assembling a protective casing for an electronic device.

### BACKGROUND

In the field of adhesive application to rigid substrates having a complex geometry, it is difficult to achieve uniformity in the adhesive layer. A non-uniform adhesive layer typically results in non-compliant adhesion of materials applied on the rigid substrate, leaving gaps, bubbles, wrinkles, and dangling edges. Apart from the aesthetically unpleasant result, a non-compliant adhesion deteriorates progressively until a functional value of the resulting structure is seriously affected. For example, when the adhesively joined layers are part of a structure for a casing of a handheld or portable electronic device, protection layers in the casing may become loose, impairing the ability to properly close or open the casing, or the ability to maintain a desired ergonomic configuration.

Some attempts at solving adhesive uniformity problems include spray devices and method of use spray devices. However, spray devices techniques are unable to control adhesive layer thickness. This may be particularly problematic, as it may be desirable to vary adhesive layer thickness in different portions of the substrate, according to the geometry. In addition, spraying techniques have the problem of clogging and channel obstruction of the spray nozzle due to the high viscosity of some adhesives used in the industry. Moreover, when using spray techniques it is difficult to alternate between different types of adhesives on a single run of the nozzle. In fact, in many instances a different spray nozzle is used for each type of adhesive, in separate spraying runs. Further attempts at solving adhesive layer non-uniformity and overcoming control issues related to spraying include the use of a roller applicator. However, while rolling works well for flat substrates, rolling applications become challenging for substrates having complex geometries, due to the rigidity and geometric constraints of the rolling heads used.

Therefore, what is desired is a method and a system for applying an adhesive layer on a substrate having a complex profile that provides uniform and seamless adhesion to the substrate. What is also needed is a method and a system for applying an adhesive layer on a substrate having a complex geometry, the method and system enabling the use of more than one adhesive in a single application run.

### SUMMARY OF THE DESCRIBED EMBODIMENTS

According to embodiments disclosed herein an adhesive applicator may include an adhesive dispenser to provide adhesive at a pressure and a compliant head adapted to rotate about a symmetry axis. In some embodiments the compliant head includes a permeable material to provide the adhesive from the dispenser to an adhesive layer on a top surface of a substrate. Furthermore, the adhesive applicator may include a driver coupled to move the compliant head so that the symmetry axis forms a trajectory on a substrate.

An applicator head in some embodiments may include a foam matrix having pores with a pre-selected pore diameter. The applicator head having a compliant surface to accommodate a substrate geometry. Accordingly, the foam matrix may have an elasticity such that the compliant surface deforms upon contact with the substrate geometry.

In some embodiments, a method for applying an adhesive layer to a substrate includes providing adhesive to an applicator head at a pressure and rotating the applicator head at a rotational speed. The method may further include placing the applicator head proximal to a substrate and allowing the applicator head to deform according to a profile of the substrate. Also, the method may include applying the adhesive to the substrate and displacing the applicator head along a substrate contour.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The described embodiments may be better understood by reference to the following description and the accompanying drawings. Additionally, advantages of the described embodiments may be better understood by reference to the following description and accompanying drawings. These drawings do not limit any changes in form and detail that may be made to the described embodiments. Any such changes do not depart from the spirit and scope of the described embodiments.

FIG. 1 illustrates a contoured adhesive applicator, according to some embodiments.

FIG. 2A illustrates a partial view of a contoured adhesive applicator, according to some embodiments.

FIG. 2B illustrates a partial view of a contoured adhesive applicator, according to some embodiments.

FIG. 2C illustrates a partial view of a contoured adhesive applicator, according to some embodiments.

FIG. 3 illustrates a partial view of a contoured adhesive applicator, according to some embodiments.

FIG. 4 illustrates a partial view of a contoured adhesive applicator, according to some embodiments.

FIG. 5 illustrates a flow chart for a method for applying an adhesive layer to a substrate, according to some embodiments.

In the figures, elements referred to with the same or similar reference numerals include the same or similar structure, use, or procedure, as described in the first instance of occurrence of the reference numeral.

### DETAILED DESCRIPTION OF SELECTED EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

In the field of portable electronic devices, such as handheld phones, tablets, and other computational appliances, the casing structure is a highly relevant feature. Electronic devices including casings manufactured using devices and methods as described herein may include cellular phones, tablets, laptops, desktops and other computational devices. Casing structures for handheld electronic devices provide protection to the electronic circuitry inside, including delicate sensor transducers. Also, casing structures are desirably adapted to harsh and varying outdoor conditions, such as exposure to high and low temperatures, and solar radiation. Also, casing structures desirably withstand intense user interaction through manipulation and other direct contact instances. Furthermore, casing structures for handheld electronic devices desirably provide a rugged platform for device display and use while the user is moving, or in any other informal circumstance. Thus, the integrity, reliability, and aesthetic quality of the casing structure is important, especially for advancing a product in an extremely competitive market. To this effect, it is desirable to have device structures that are reliably assembled, for which the application of adhesives is an important step.

Typically, adhesives are applied for adhesively coupling a rigid substrate and a fabric cover. The rigid substrate, or shell, may have a complex geometry including intricate features, to accommodate for different electronic components and sensors in a typically reduced volume. It is thus desirable that the fabric cover adheres to the shell smoothly and securely across the entire surface, including the detailed features.

In embodiments consistent with the present disclosure an applicator head includes a foam or another compliant material that is contoured to the substrate geometry as the adhesive is applied to it. In such configurations, since the foam is compliant and not rigid, the applicator head adapts to varying substrate geometries. Thus, the applicator head may have a generic shape that adapts to different geometries encountered in the shell. Even when the applicator head has a cylindrical shape with a radius larger than the radius of curvature of a feature in the shell, a compliant foam may deform accordingly to make a soft and even contact with the feature surface. Also, a foam as used in some embodiments provides permeability for an adhesive to flow through the applicator head and evenly cover a substrate. One of ordinary skill will recognize that the material forming an applicator head consistent with the present disclosure is not limited to a porous foam. More generally, an applicator head consistent with the present disclosure may be formed of a permeable material having a resilience. A resilient material has flexibility to adapt and comply with a profile when in contact with a hard substrate, providing a relatively low pressure force against the substrate. When the resilient material is removed from contact with the hard substrate, it recovers its original shape and volume.

In some embodiments the applicator includes an adhesive dispenser coupled to the applicator head. The glue dispenser may control the volume and pressure of glue dispensed into the compliant applicator head. Furthermore, the inherent porosity of the foam allows for the adhesive to evenly impregnate the applicator head and provide a homogeneous adhesive layer across the contact surface between the applicator head and the substrate.

FIG. 1 illustrates a contoured adhesive applicator 100, according to some embodiments. Applicator 100 includes applicator head 101, and an adhesive dispenser 110. Dispenser 110 provides an adhesive 120 to applicator head 101. Applicator head 101 provides a layer 125 of adhesive 120 on a top surface 151 of substrate 150. Substrate 150 may include a shell for a casing of an electronic device as discussed above. In some embodiments it is desirable that adhesive layer 125 be smooth and continuous across the entire exposed surface of substrate 150. In order to provide adhesive layer 125, applicator head 101 is adapted to rotate about an axis of symmetry ‘A’ as adhesive layer 125 is formed, according to some embodiments. In that regard, axis ‘A’ may be parallel or overlapping with an axis of adhesive dispenser 110. Applicator head 101 may include a permeable material that is compliant with a geometry of a hard substrate. The permeable material may receive the adhesive from dispenser 110 and provide adhesive 120 to adhesive layer 125 on top surface 151. In that regard, the permeable material forming applicator head 101 receives adhesive 120 from dispenser 110 and permeably distributes adhesive 120 into adhesive layer 125 on the compliant surface of the applicator head.

Contoured adhesive applicator 100 may also include a driver 170 coupled to applicator head 101 to displace or translate applicator head 101 such that the symmetry axis ‘A’ remains substantially orthogonal to a flat region of top surface 151. In some embodiments, applicator head 101 and driver 170 may be mounted to a computer numerical control (CNC) router. In such configuration, the CNC router rolls the applicator head along a trajectory on top surface 151, smoothly applying an even amount of adhesive in a single pass. Accordingly, in some embodiments the rotational speed of applicator head 101 is adjusted relative to the displacement of axis ‘A’ so as to avoid slippage between a contact surface between applicator head 101 and top surface 151. For example, in some embodiments contoured adhesive applicator 100 may include a sensor 175 to determine the magnitude of a contact force between applicator head 101 and top surface 151. When the magnitude of the contact force exceeds a threshold value, the rotational speed of the applicator head 101 may be reduced. Likewise, when the magnitude of the contact force falls below a certain value, a slow increase in rotational speed of applicator head 101 may be applied. Thus, facilitating a smooth rollover of applicator head 101 on top surface 151.

In some embodiments, contoured adhesive applicator 100 may be adapted to adjust the proximity between applicator head 101 and top surface 151 according to the value sensed for the contact force. Thus, when the contact force is lower than a threshold value, applicator head 101 may be displaced closer to top surface 151. Likewise, when the contact force is higher than a threshold value, applicator head 101 may be displaced farther from top surface 151.

FIG. 2A illustrates a partial view of contoured adhesive applicator 200, according to some embodiments. In FIG. 1 dispenser 110 and adhesive 120 may be as described in detail above (cf. FIG. 1). Applicator head 201A includes a foam matrix having pores 210. The size of the pores may be selected according to the viscosity of adhesive 120 and the desired speed of application of glue layer 125 (cf. FIG. 1). In that regard, the pore size in the foam matrix may form a distribution having a mean and a variance. The foam matrix may be manufactured such that the mean value and the variance have a desired value, or have values within desired tolerances. Accordingly, embodiments of applicator head 201A include materials forming a compliant surface to accommodate a substrate geometry. According to some embodiments, a resilient material having an elasticity may be desirable. For example, a foam matrix forming applicator head 101 may have an elasticity such that the compliant surface deforms upon contact with the substrate geometry and recovers an original shape and volume when the compliant surface is removed from contact.

In some embodiments, the foam in applicator head 201A may have an open cell configuration. In an open cell configuration, pores 210 are multiply connected, so that adhesive 120 percolates through the foam in multiple random paths. Accordingly, different foam configurations may be used as desired for a specific application. For example, the pore size and orientation in the foam matrix may be adjusted to control the amount of adhesive applied to different areas of top surface 151. Other factors in contour applicator 200 may be used to control the amount of adhesive applied to different areas of the shell, such as a rotation speed of the applicator head. Other factors that may affect the thickness of adhesive layer 125 include the pressure of the adhesive coming out of dispenser 110, or a contact pressure between applicator head 201A and top surface 151.

FIG. 2B illustrates a partial view of contoured adhesive applicator 200, according to some embodiments. Applicator 200 includes applicator head 201B having two foam portions concentrically arranged about axis ‘A’: a central portion 205 and a peripheral portion 206. Applicator 200 also includes two adhesive dispensers: dispenser 210 provides a first adhesive 220 to central portion 205, and dispenser 211 provides a second adhesive 221 to peripheral portion 206. Applicator 200 may also include a first collector 230 below dispenser 210 and a second collector 231 below dispenser 211. Collector 230 may prevent the overflow of adhesive 220 into peripheral portion 206. Likewise, collector 231 may also prevent the overflow of adhesive 221 into central portion 205. Moreover, in some embodiments collectors 230 and 231 homogenize the flow of adhesive 220 and 221 into the porous matrix of central portion 205 and peripheral portion 206, respectively.

Accordingly, central portion 205 may be a foam including a first porous matrix having pores 215. Likewise, peripheral portion 206 may be a foam including a second porous matrix having pores 216. In some embodiments, the size of pores 215 may be different from the size of pores 216. For example, in some embodiments pores 215 may have a first diameter smaller than a second diameter of pores 216. In some embodiments, the size of pores 215 and 216 may be related to a viscosity of the adhesive flowing through the pores. For example, adhesive 220 flowing through pores 215 having a reduced diameter may have a lower viscosity than adhesive 221 flowing through pores 216 having a larger diameter. Thus, embodiments consistent with the present disclosure include a contoured adhesive applicator 200 that applies two different adhesives having different viscosities in a single applicator run. Moreover, the use of an applicator head such as head 201B enables the application of different adhesives in preselected portions of top surface 151. In addition, embodiments consistent with the present disclosure may use adhesives having higher viscosity without need for cleaning or unclogging a dispenser nozzle, since a dedicated dispenser may be used for a higher viscosity adhesive.

FIG. 2C illustrates a partial view of contoured adhesive applicator 200, according to some embodiments. In FIG. 2C, dispensers 210 and 211, and collectors 230 and 231 may be as described in detail above (cf. FIG. 2B). Applicator head 201C includes a closed cell foam having pores 251 in a central portion and pores 252 in a peripheral portion. A closed cell foam as used in some embodiments includes pores having a defined path within the foam matrix. Accordingly, when an adhesive 220 is injected through a collector 220 from a dispenser 210, adhesive 220 will flow through pores 251 and leave applicator head 201C on the central portion. Likewise, when an adhesive 221 is injected through a collector 231 from a dispenser 211, adhesive 221 flows through pores 252 and leave applicator head 201C form the sidewalls.

Thus, a more targeted adhesive application may be obtained with a closed cell configuration. For example, adhesive 221 may have different chemical and physical characteristics than adhesive 220. In some embodiments, adhesive 221 may be more viscous than adhesive 220. Also according to some embodiments, dispenser 211 may provide adhesive 221 at a different pressure or at a different flow rate than dispenser 210 provides adhesive 220. For example, dispenser 211 may provide adhesive 221 at a higher pressure or a higher flow rate than dispenser 210 provides adhesive 220, thus providing a larger amount of adhesive through pores 252 than through pores 251. In that regard, pores 252 may also have a different diameter from pores 251, so as to provide a different adhesive rate to top surface 151. In some embodiments, a closed cell configuration as shown in FIG. 2C may be used to form an adhesive layer 125 that has a different thickness in different portions of top surface 151. This will be described in more detail with reference to FIG. 3 below.

FIG. 3 illustrates a partial view of contoured adhesive applicator 300, according to some embodiments. Applicator 300 includes applicator head 301 providing an adhesive layer 125 to top surface 151. Adhesive layer 125 may have different thicknesses in different portions of top surface 151. For example, in a flat portion of the top surface of substrate 150, applicator head 300 provides adhesive layer 125 with a reduced thickness 326. In a sidewall and lip portion of top surface 151, applicator head 300 provides adhesive layer 125 with an increased thickness 325. Having thinner glue layer portion 326 may be desirable in some applications wherein the flatness of top surface 151 may enable proper adherence of a material layer adhesively joined to substrate 150. In such geometries, having a reduced amount of adhesive may be beneficial to avoid lumps of adhesive material creating wrinkles in the material layer adhesively joined to substrate 150. Likewise, having increased thickness 325 in a portion of adhesive layer on a sidewall and a lip portion may be desirable to securely attach a material layer adhesively joined to substrate 150, since a sidewall and a lip portion may be exposed to stress, tear, and wear of the resulting structure.

Accordingly, applicator 300 provides a differentiated adhesive layer 125 in a single application run over top surface 151. For example, in some embodiments applicator head 301 may be as applicator head 201C (cf. FIG. 2C) having different pore matrices in close proximity with different portions of top surface 151 (e.g., central portion 205 and peripheral portion 206).

FIG. 4 illustrates a partial view of contoured adhesive applicator 400, according to some embodiments. Applicator 400 includes adhesive dispenser 110, described in detail above (cf. FIG. 1). Dispenser 110 provides an adhesive precursor 420 to applicator head 401. Accordingly, adhesive precursor 420 becomes adhesive 120 inside applicator head 401. In some embodiments, a chemical reaction between precursor 420 and a component embedded in applicator head 401 may form adhesive 120 from precursor 420. In that regard, a chemical component reactive with adhesive precursor 420 may be embedded in a porous matrix included in applicator head 401. Adhesive 120 may be provided to top surface 151 and form adhesive layer 125, as described in detail above (cf. FIGS. 1 and 3).

In some embodiments, contact between adhesive precursor 420 and a foam matrix in applicator head 401 may result in an exothermic chemical reaction. The heat generated by the exothermic chemical reaction thus raises the temperature of adhesive 120 which may be a thermosetting adhesive, or a thermoplastic adhesive. Thus, as adhesive 120 is transferred from applicator head 401 onto top surface 151, it is ready to form adhesive layer 125.

FIG. 5 illustrates a flow chart for a method 500 for applying an adhesive layer to a substrate, according to some embodiments. Steps in method 500 may be completely or partially performed by a machine including a contour adhesive applicator having an applicator head (e.g., contour adhesive applicator 100, and applicator head 101, cf. FIG. 1). The machine performing method 500 may be a CNC machine, as discussed in detail above. Accordingly, the contour adhesive applicator may also include a dispenser to provide an adhesive to the applicator head (e.g., dispenser 110, cf. FIG. 1), and a sensor to measure a contact force between the applicator head and the substrate (e.g., sensor 175, cf. FIG. 1). The contour adhesive applicator performing method 500 may also include a driver 170 adapted to move the applicator head above a top surface in the substrate (e.g., driver 170, cf. FIG. 1). The substrate in method 500 may be a hard shell having a complex geometry and a top surface for applying the adhesive (e.g., substrate 150 and top surface 151, cf. FIG. 1).

Step 510 includes providing an adhesive to the applicator head at a pressure. Accordingly, in some embodiments step 510 is performed via the dispenser in the adhesive applicator. In embodiments where the applicator head includes a permeable material, the adhesive permeates through the applicator head, reaching a contact surface between the applicator head and the substrate. In some embodiments, the permeable material may be a foam matrix and the adhesive may be homogeneously distributed through a volume in the applicator head, filling all or almost all of the pores in the foam matrix.

Step 520 includes rotating the applicator head. In some embodiments, step 520 includes rotating the applicator head about an axis through the center of the applicator head. For example, the rotation axis may be parallel or super-imposed to an axis of the adhesive dispenser. Accordingly, step 520 may be performed by a mechanical gear in the driver coupled to the applicator head (e.g., driver 170 and applicator head 101, cf. FIG. 1).

Step 530 includes placing the applicator head proximal to the substrate. In some embodiments, step 530 may include contacting a surface in the substrate with a portion of the applicator head soaked in the adhesive. Step 530 may include measuring a contact force between the applicator head and the substrate. For example, step 530 may include measuring the contact force with a pressure sensor or a torque sensor adapted to a rotating shaft moving the applicator head (e.g., sensor 175, cf. FIG. 1). When the contact force is less than a threshold value, step 530 may include displacing the applicator head closer to the substrate. When the contact force is greater than a threshold value, step 530 may include moving the applicator head away from the substrate. Step 540 includes allowing the applicator head to deform according to a substrate profile.

Step 550 includes applying the adhesive to the substrate. In some embodiments, the pressure on the porous matrix as the applicator head is placed in proximity with the substrate produces an ejection of adhesive out of the applicator head. In some embodiments, step 550 may include chemically reacting a component in the foam matrix of the applicator head with an adhesive precursor provided by the dispenser. Accordingly, step 550 may further include forming an adhesive from the chemical reaction between the foam matrix component and the adhesive precursor. For example, the adhesive precursor may be a thermosetting adhesive or a thermoplastic adhesive forming an adhesive layer from heat released in the chemical reaction. Step 560 includes displacing the applicator head along a contour of the substrate. In some embodiments, the applicator head is displaced at a speed such that a contact point between the substrate and the applicator head remains stationary relative to the substrate. Accordingly, step 560 includes forming an adhesive layer along the contour of the substrate.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. An adhesive applicator comprising:
an adhesive dispenser to provide adhesive at a pressure;
a compliant head adapted to rotate about a symmetry axis; the compliant head comprising a permeable material to provide the adhesive from the dispenser to an adhesive layer on a top surface of a substrate; and
a driver coupled to move the compliant head so that the symmetry axis forms a trajectory on the substrate.

2. The adhesive applicator of claim 1 wherein the permeable material comprises a porous matrix having pores with a pre-selected pore diameter.

3. The adhesive applicator of claim 2 wherein the porous matrix comprises an open cell foam.

4. The adhesive applicator of claim 2 wherein the porous matrix comprises a closed cell foam.

5. The adhesive applicator of claim 4 wherein the closed cell foam comprises a first plurality of pores having a first diameter in a central portion of the compliant head and a second plurality of pores having a second plurality in a peripheral portion of the compliant head.

6. The adhesive applicator of claim 5 further comprising a first dispenser to provide a first glue to the central portion of the applicator head and a second dispenser to provide a second glue to the peripheral portion of the compliant head.

7. The adhesive applicator of claim 5 further comprising a first collector above the central portion of the compliant head and a second collector above the peripheral portion of the compliant head.

8. The adhesive applicator of claim 1 wherein the permeable material comprises a central portion having a first porous matrix and a peripheral portion having a second porous matrix.

9. The adhesive applicator of claim 8 wherein the first porous matrix comprises pores having a first diameter smaller than a second diameter of pores in the second porous matrix.

10. The adhesive applicator of claim 1 further comprising a sensor to determine a contact force between the compliant head and a substrate.

11. An applicator head comprising:
a foam matrix having pores with a pre-selected pore diameter; and
a compliant surface to accommodate a substrate geometry; wherein
the foam matrix has an elasticity such that the compliant surface deforms upon contact with the substrate geometry.

12. The applicator head of claim 11 wherein the foam matrix comprises an open cell foam.

13. The applicator head of claim 11 wherein the foam matrix comprises a closed cell foam.

14. The applicator head of claim 13 wherein the closed cell foam comprises a first plurality of pores having a first diameter in a central portion of the applicator head and a second plurality of pores having a second plurality in a peripheral portion of the applicator head.

15. The applicator head of claim 11 wherein the foam matrix comprises a central portion having a first plurality of pores with a first pore diameter and a peripheral portion having a second plurality of pores with a second pore diameter.

16. The applicator head of claim 15 wherein the foam matrix comprises a component that is chemically reactive with an adhesive precursor provided by the dispenser.

17. A method for applying an adhesive layer to a substrate, the method comprising:
providing adhesive to an applicator head at a pressure;
rotating the applicator head at a rotational speed;
placing the applicator head proximal to a substrate;
allowing the applicator head to deform according to a profile of the substrate;
applying the adhesive to the substrate; and
displacing the applicator head along a substrate contour.

18. The method of claim 17 wherein placing the applicator head proximal to the substrate comprises applying a contact force between a compliant surface in the applicator head and the substrate.

19. The method of claim 18 further comprising measuring the contact force.

20. The method of claim 19 further comprising adjusting a rotational speed according to the measured contact force.
